(19) United States
(12) Patent Application Publication
(10) Pub. No.: US 2002/0184397 A1
(43) Pub. Date: Dec. 5, 2002

(54) Method and apparatus for providing a custom cataloging procedure

(76) Inventor: Raymond Cooper, Burnaby (CA)

Correspondence Address: Fasken Martineau DuMoulin LLP, Toronto-Dominion Centre, Box 20, Suite 4200, Toronto Dominion Bank Tower, Toronto, ON, M5K 1N6, CA

(21) Appl. No.: 10/076,065

(22) Filed: Feb. 15, 2002

Related U.S. Application Data
(60) Provisional application No. 60/269,749, filed on Feb. 15, 2001.

(51) Int. Cl. G06F 9/00

(52) U.S. Cl. 709/310

(57) ABSTRACT

A method for cataloguing information for at least one family of products, each product in said family having at least one or more configurations, said method comprising the steps of creating an XML document containing said product family information, including said product configurations; storing said XML documents in a database, and associating with said document an identifier for said document; allowing a user to select at least one family from a displayed list of families, such that when the user selects said family the XML documents corresponding thereto is retrieved from said database, using said identifier; and presenting to said user, product information contained in said retrieved XML document.

The invention relates to the field of product cataloging, and more particularly to cataloguing product family information for an online product display system.

### BACKGROUND OF THE INVENTION

Most online or software product catalogues use a for example in (most department store sites) use a cascading menu structure, to allow a user to “drill down” to the final product listing that they are interested in. Once the final category is selected, users are then typically presented with a selected list of products to choose from. A relational database structure to represent the relationship between the menu or organizational structure and the products themselves.

Referring to FIG. 1, there is shown a screen capture illustrating a product catalogue display in accordance with the prior art. The product display illustrated in FIG. 1 is typical when using existing database technology. Information for each product 100, 110, 120, 130 is typically stored in a separate row in a database, as each product's price is a function of the combination of “options” available for that product. For example, the prices of the two VCRs 110, 120 are dependent on their size, manufacturer, options, sale markdown, etc. This data is typically stored in one or more linked database tables.

Referring to FIG. 2, there is shown a block diagram illustrating product cataloguing relational database tables 200 in accordance with the prior art. Typically, the number of rows in each table 200 increases with the number of distinct products in the catalogue. For example, a company that supplies kitchen cabinets may have 100 different cabinets. Options such as type, size, finished ends, and material will greatly increase the number of configured products. For example, say each cabinet requires 170 rows for its various configurations. Loading data for all these configurations into a database to represent individually priced products will result in over 17,000 rows of data.

Furthermore, with traditional cataloguing systems, database design may be affected by the product options available. New products with different options may not fit into the existing structure, necessitating either a database redesign or a separate database for each new product. Thus, one disadvantage of typical known product catalogues is that they require the maintenance of a large amount of data. A second disadvantage of known catalogues is that their structure often required redesign to accommodate new products.

A need therefore exists for a method to retrieve information on products and that facilitates the addition of new products without requiring redesign. Consequently, it is an object of the present invention to obviate or mitigate at least some of the above mentioned disadvantages.

### SUMMARY OF THE INVENTION

The invention provides a product catalog that catalogs product family information using XML documents. According to one aspect of the invention, there is provided a method for cataloguing information for at least one family of products, each product in said family having at least one or more configurations, said method comprising the steps:

a) creating an XML document containing said product family information, including said product configurations;

b) storing said XML documents in a database, and associating with said document an identifier for said document;

c) allowing a user to select at least one family from a displayed list of families, such that when the user selects said family the XML documents corresponding thereto is retrieved from said database, using said identifier, and

d) presenting to said user, product information contained in said retrieved XML document.

According to another aspect of the invention, a method is provided wherein the catalog is displayed by means including an Internet application, a web page, standalone software, and an XML document.

According to another aspect of the invention, a method is provided wherein the product family information source is a data input screen. According to another aspect of the invention, a method is provided wherein the product family information source is an XML document According to another aspect of the invention, a method is provided wherein the menu information source is a data input screen. According to another aspect of the invention, a method is provided wherein the menu information source is an XML document. According to another aspect of the invention, a method is provided wherein the XML document is received from the Internet.

According to another aspect of the invention, a method is provided wherein the database is a relational database. According to another aspect of the invention, a method is provided wherein the XML menu and product family documents for the product family information are stored in one record of the relational database.

In general, the invention described herein provides a product catalog that catalogs product family information producing XML documents. The invention is applicable to cascading menus or related data structures for general purpose use.

The invention provides methods of designing, storing and presenting data that allows for a reduction of the amount of physical data storage necessary while mitigating data redesign issues. According to the invention, a single database table data row is created that represents all of the physical configurations of a product, including pricing information or for retrieving the information on an product and its configurations and passing the an XML string to produce the same results.

### BRIEF DESCRIPTION OF THE DRAWINGS

The invention may best be understood by referring to the following description and accompanying drawings, which illustrate the invention. In the drawings:

FIG. 1 is a screen capture illustrating a product catalogue display in accordance with the prior art;

FIG. 2 is a block diagram illustrating relational database tables and linkages for product cataloguing in accordance with the prior art;

FIG. 3 is a block diagram illustrating a data structure for product cataloguing in accordance with one embodiment of the invention;

FIG. 4 is a screen capture illustrating an exemplary product catalogue display for a casement window in accordance with one embodiment of the invention;

FIG. 5 is a flow chart illustrating a product cataloguing method in accordance with one embodiment of the invention;

FIG. 6 is a block diagram illustrating an exemplary data processing system for implementing the product cataloging method in accordance with one embodiment of the invention;

FIG. 7 is a flowchart illustrating a category administration method in accordance with one embodiment of the invention;

FIG. 8 is a screen capture illustrating a category administration screen in accordance with one embodiment of the invention;

FIG. 9 is a table listing controls used in the administration screen of FIG. 8;

FIG. 10 is an entity diagram illustrating a clsCategoryXML COM object in accordance with one embodiment of the invention;

FIG. 11 is a table listing API interface descriptors for the clsCategoryXL COM object of FIG. 10;

FIG. 12 is an entity relationship diagram (ERD) illustrating tables related to the Category Administration application in accordance with one embodiment of the invention;

FIG. 13 is a table listing table and field descriptions corresponding to FIG. 12;

FIG. 14 is a block diagram illustrating a document type definition (DTD) schema describing XML documents for MRS classifications in accordance with one embodiment of the invention;

FIG. 15 is a table listing tag descriptions for the DTD of FIG. 14;

FIG. 16 is a listing illustrating an exemplary Categories XML document in accordance with one embodiment of the invention;

FIG. 17 is a flowchart illustrating a category selection method for a first page including cascading menu in accordance with one embodiment of the invention;

FIG. 18 is a flowchart illustrating a category selection method for a selection page in accordance with one embodiment of the invention;

FIG. 19 is a screen capture illustrating a first page screen in accordance with one embodiment of the invention;

FIG. 20 is a table listing controls used in the first page screen of FIG. 19; FIG. 21 is a screen capture illustrating a selection page screen in accordance with one embodiment of the invention;

FIG. 22 is a table listing controls used in the selection page screen of FIG. 21;

FIG. 23 is an entity diagram illustrating a clsDivision COM object in accordance with one embodiment of the invention;

FIG. 24 is a table listing API interface descriptors for the clsDivision COM object of FIG. 23;

FIG. 25 is an entity diagram illustrating a clsXMLCategory COM object in accordance with one embodiment of the invention;

FIG. 26 is a table listing API interface descriptors for the clsXMLCategory COM object of FIG. 25;

FIG. 27 is an entity relationship diagram (ERD) illustrating tables related to an XML Menu Specification application in accordance with one embodiment of the invention;

FIG. 28 is a table listing table and field descriptions corresponding to FIG. 27;

FIG. 29 is a table listing interfaces to a selection page for an XML Menu Specification application in accordance with one embodiment of the invention;

FIG. 30 is a table listing interfaces to a product display page (PDP) for an XML Menu Specification application in accordance with one embodiment of the invention;

FIG. 31 is a flowchart illustrating a product specification method in accordance with one embodiment of the invention;

FIG. 32 is a screen capture illustrating a product screen in accordance with one embodiment of the invention;

FIG. 33 is a table listing controls used in the first page screen of FIG. 32;

FIG. 34 is a screen capture illustrating an additional product information screen in accordance with one embodiment of the invention;

FIG. 35 is a table listing controls used in the additional product information screen of FIG. 34;

FIG. 36 is an entity diagram illustrating a Product Entity object in accordance with one embodiment of the invention;

FIG. 37 is a table listing API interface descriptors for the Product Entity object of FIG. 36;

FIG. 38 is an entity diagram illustrating a Product Broker object in accordance with one embodiment of the invention;

FIG. 39 is a table listing API interface descriptors for he Product Broker object of FIG. 38;

FIG. 40 is a UML diagram for the Product Broker object of FIG. 38;

FIG. 41 is an entity diagram illustrating a Pricing Info Entity object in accordance with one embodiment of the invention;

FIG. 42 is a table listing API interface descriptors for the Pricing Info Entity object of FIG. 41;

FIG. 43 is an entity relationship diagram (ERD) illustrating tables related to the Product Specification application in accordance with one embodiment of the invention;

FIG. 44 is a table listing table and field descriptions corresponding to FIG. 43; and,

FIG. 45 is a table listing interfaces to a worksheet for the Product Specification application in accordance with one embodiment of the invention.

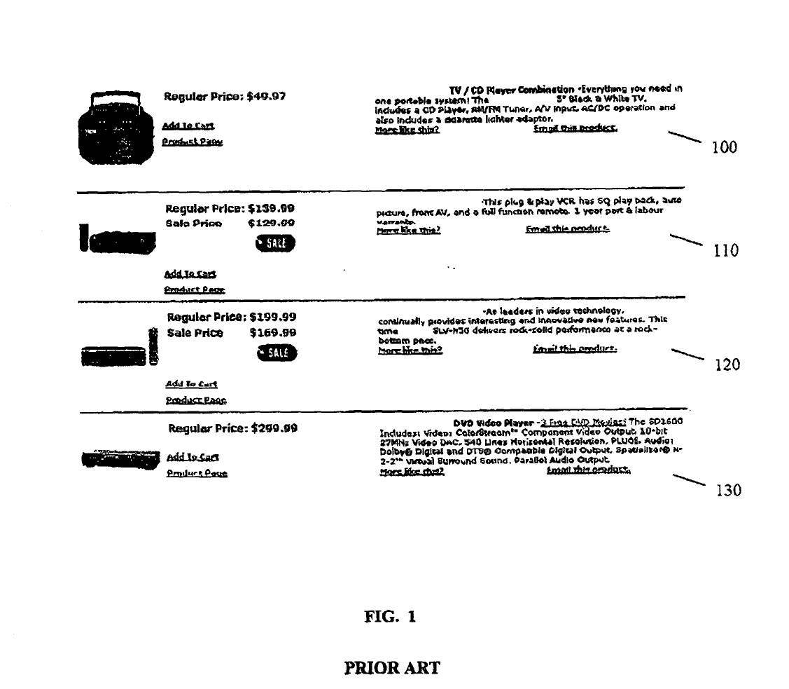

### DETAILED DESCRIPTION OF THE PREFERRED EMBODIMENTS

In the following description, numerous specific details are set forth to provide a thorough understanding of the invention. However, it is understood that the invention may be practiced without these specific details. In other instances, well-known software, circuits, structures and techniques have not been described or shown in detail in order not to obscure the invention. The term data processing system is used herein to refer to any machine for processing data, including the computer Systems and network arrangements described herein. In the drawings, like numerals refer to like structures or processes.

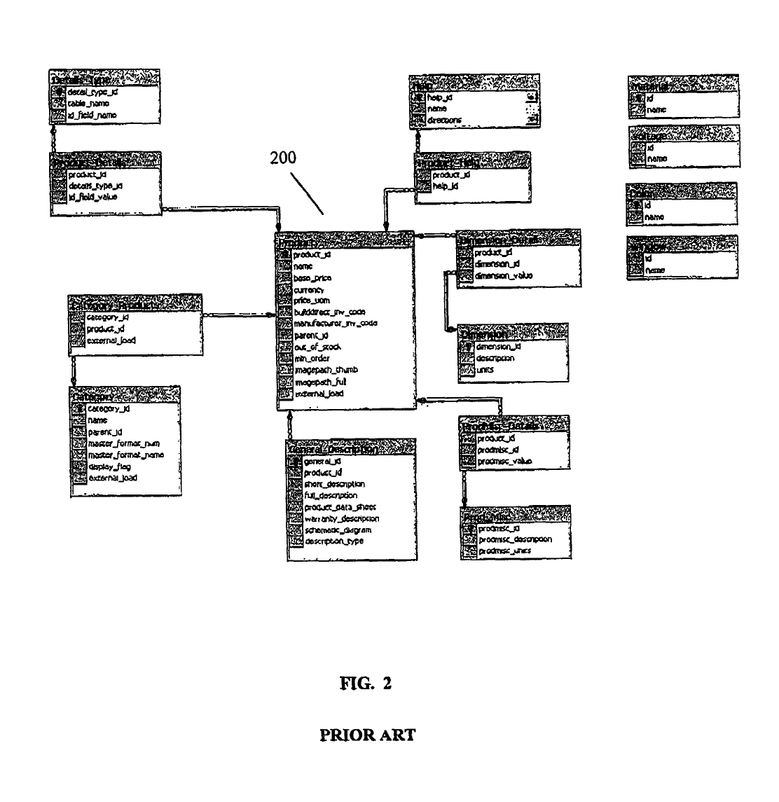

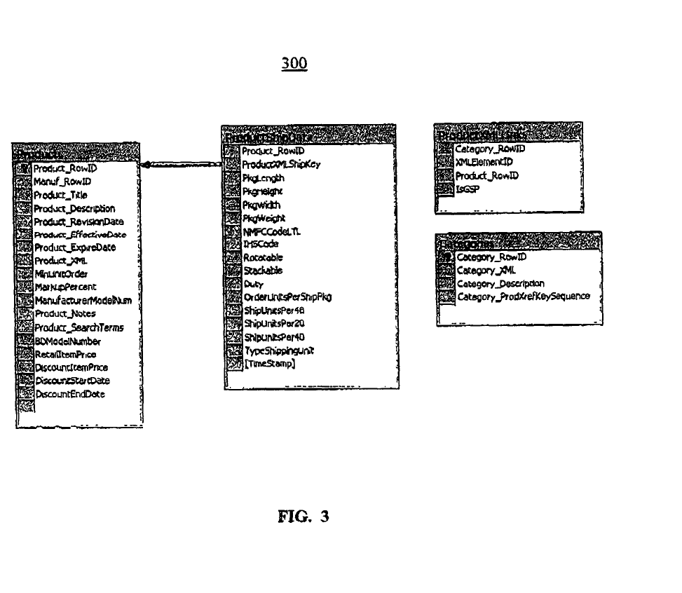

Referring to FIG. 3, there is shown a block diagram illustrating a data structure for product cataloguing in accordance with one embodiment of the invention. In FIG. 3, the data structure is shown generally by numeral 300. The data structure 300 is has been optimized to store only the data required by the product catalog of the present invention. The simplicity of the data structure 300 is apparent when compared to that of the prior art as illustrated in FIG. 2.

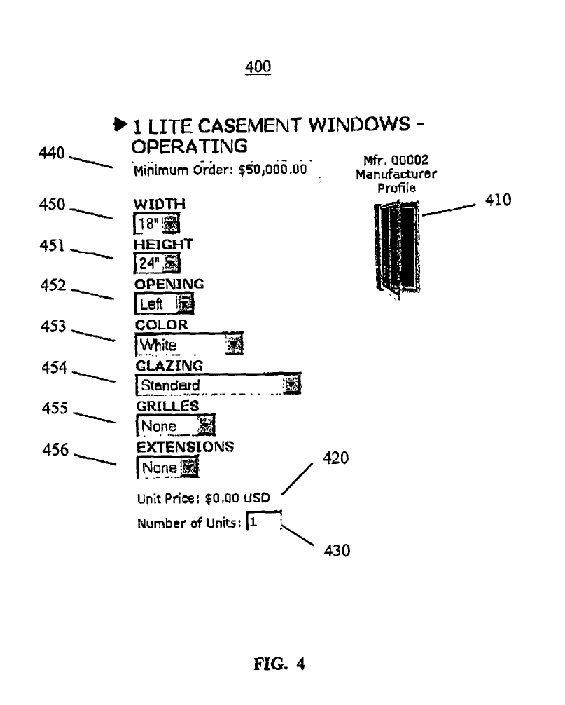

Referring to FIG. 4, there is shown a screen capture of an exemplary product catalogue display 400 for a casement window in accordance with one embodiment of the invention. All of the configurations of a product may be selected using a single display 400. The display 400 includes an image 410 of a currently selected configuration, the unit price 420, the number of units required 430, minimum order amount 440, and pull down menus for the casement window's width 450, height 451, opening 452, colour 453, glazing 454, grilles 455, and extrusions 456.

Now, XML (Extensible Markup Language) is a set of rules for designing text fonnats that allow users to structure data. This enables computers to output, read and interpret the data more easily. Like HTML (HyperText Mark-Up Langage), XML uses tags to delimit and define pieces of text and data in a document or file. A key difference, however, is that what the tag means is defined. For example, a <title> tag in HTML is always used the same way in all HTML documents, but a similar tag in XML could be used to store the name of a book, a vehicle title number or even somebody's professional status. The specific meaning is defined by the application reading the data through a data. type definition or an XML schema format. The tagged XML data is stored in a plain text file, unlike standard databases that use binary and other proprietary formats. The benefit of text being that any type of computer operating system can read a plain text file.

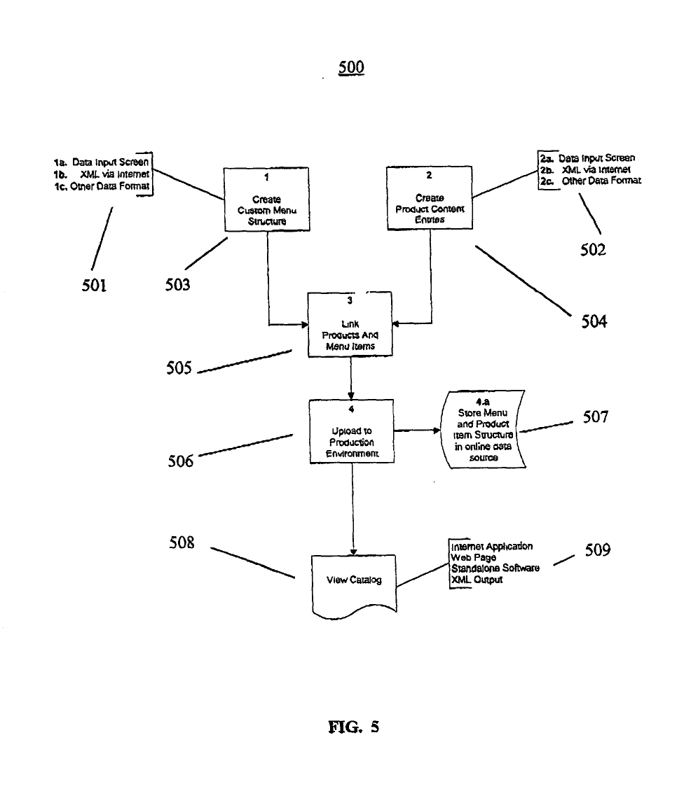

Referring to FIG. 5, there is shown a flow chart 500 illustrating a method for creating and viewing product cataloguing in accordance with one embodiment of the invention. Input data sources are of two types: menu 501 and product 502. Input data sources 501, 502 may include a data input screen, XML via the Internet, or another data format. Menu data 501 is used to build 503 the structure for drilling down to the end product grouping. Product data 502 describes the configured product 504 that is found at the end of the selected menu. The menu can be of any structure including tree data, mouse over menu, and selection boxes. The menu structure is variable as the invention simply describes and stores the data independent of the display medium. Likewise, with respect to product data, the invention only describes and stores the data for product display. How that data is actually displayed is immaterial. FIG. 4 illustrates one display option. According to the cataloguing method, menu and product data 501, 502 from various sources is received and is converted into a series of XML data documents 503, 504 The menu XML 503 contains all menu levels and sublevels, with link elements to the product in references. The product XML 504 contains the data for all configurations of that product. Once completed, the menu and product XML documents are then linked 505 and stored 506, 507 in a common relational database, As XML is a data description language only, the catalog output is filly configurable 508, 509. Again, FIG. 4 illustrates a sample Internet web page display. The catalogue may be viewed 508 using an Internet application, web page, standalone software, or as an XML document 509. The catalogue can incorporated into client-server software, a WAP enabled cell phone, or shopping mall kiosk system.

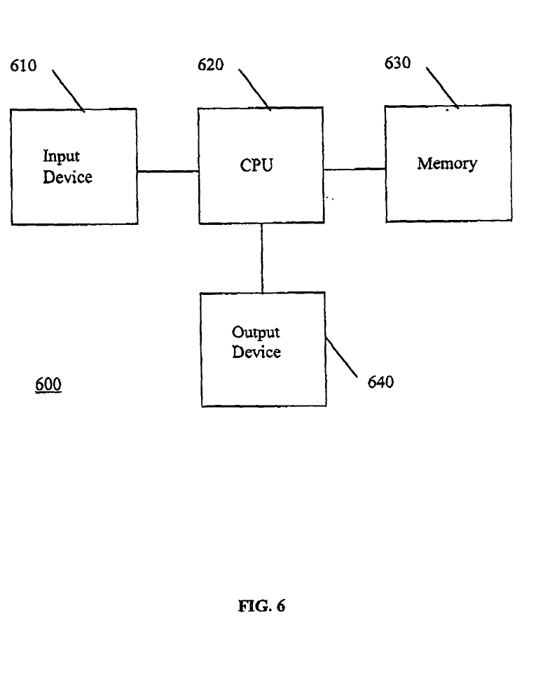

Referring to FIG. 6, there is shown a block diagram illustrating an exemplary data processing system 600 for implementing the product cataloging method in accordance with one embodiment of the invention. The data processing system is suitable for use as a product cataloging system. The data processing system 600 includes an input device 610, a central processing unit or CPU 620, memory 630, and an output device 640. The input device 610 may include a keyboard, a mouse, a trackball, a network connection, an Internet connection, or similar device. The CPU 620 may include dedicated coprocessors and memory devices. The memory 630 may include RAM, ROM, databases, or disk devices. The output device 640 may include a computer screen, a terminal device, a television, a CD-ROM, a floppy disk, a printer, a network connection, an internet connection, or similar device. The data processing system 600 has stored therein data representing sequences of instructions which when executed cause the method described herein to be performed. Of course, the data processing system 600 may contain additional software and hardware a description of which is not necessary for understanding the invention.

In addition, the sequences of instructions which when executed cause the method described herein to be performed by the exemplary data processing system of FIG. 6 can be contained in a computer software product according to one embodiment of the invention. This computer software product can be loaded into and run by the exemplary data processing system of FIG. 6. Moreover, the sequences of instructions which when executed cause the method described herein to be performed by the exemplary data processing system of FIG. 6 can be contained in an integrated circuit product including a coprocessor or memory according to one embodiment of the invention. This integrated circuit product can be installed in the exemplary data processing system of FIG. 6.

Having provided a high level description of the invention, in the following a more detailed description of the primary software applications for implementing the product cataloguing method is provided. These applications include the following: Category Administration, XML Menu Specification, and Product Specification.

Category Administration

Definitions. Consider the following definitions:

CSI Format: The standard CSI Master Format categories classification.

PCM Format: The applicant's Product Category Menu Format categories classification.

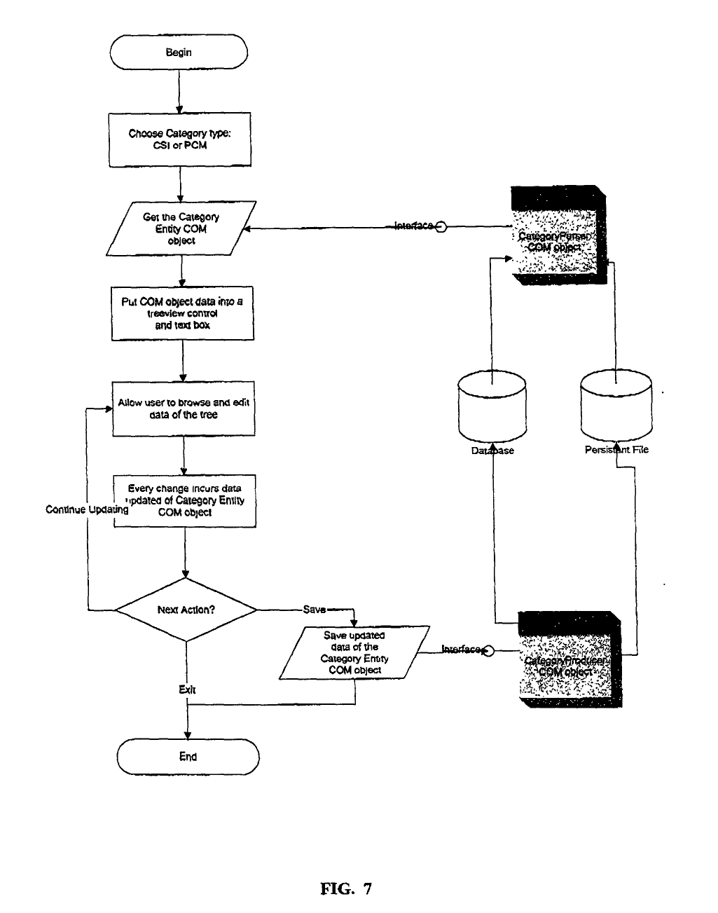

Process Flow. The Category Administration application can be written in many platform languages. The treeview control is just one way to view the Category XML structure (see below). At the same time, a consistent interface would be chosen to handle either CSI Format or PCM Format category classifications. A user may select the type of Category from the menu bar, and then he may edit the contents within the same GUI. Referring to FIG. 7, there is shown a flowchart illustrating a category administration method in accordance with one embodiment of the invention.

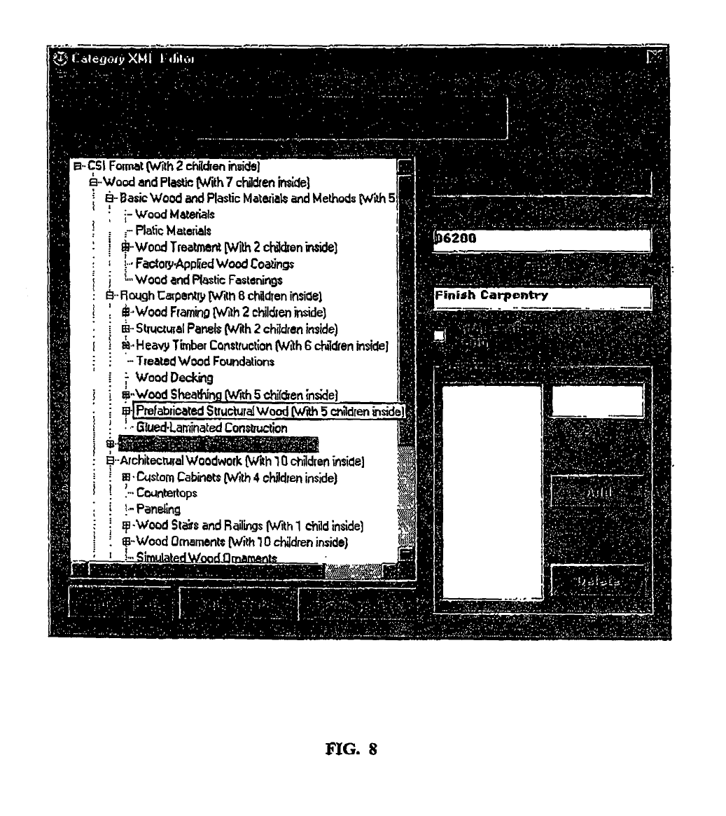

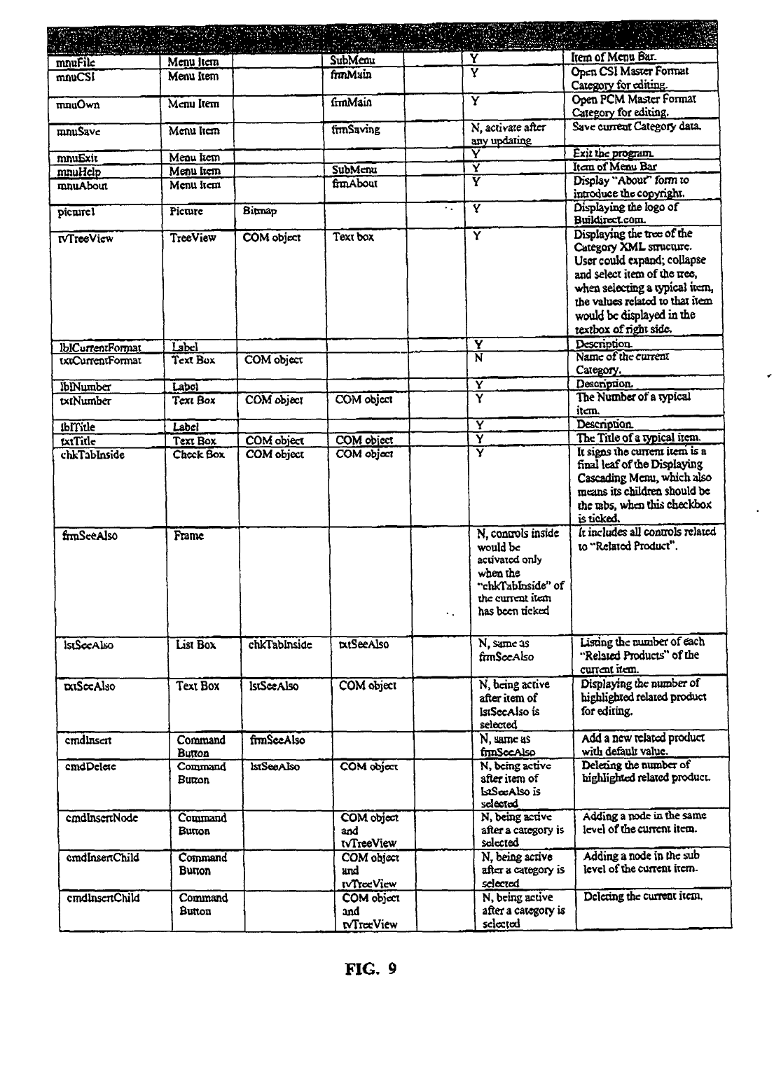

Screens. Referring to FIG. 8, there is shown a screen capture illustrating a category administration screen in accordance with one embodiment of the invention. Referring to FIG. 9, there is shown a table listing controls used in the administration screen of FIG. 8.

Middle Tier Objects. Middle tier objects for the category administration application include the following:

clsDivision: Serves to hold information of every division, it will include a collection of clsDivision object recursively if in need.

clsXMLCategory: Provides method to return the first root clsDivision object from Category XML structure stored in database.

clsCategoryXML: Provides method to generate XML structure from the current clsDivision object and save it in database.

With respect to object dependence, clsXMLCategory and clsCategoryXML are based on the existence of clsDivision. The clsDivision and clsXMLCategory are described below in relation to the Production Classification application.

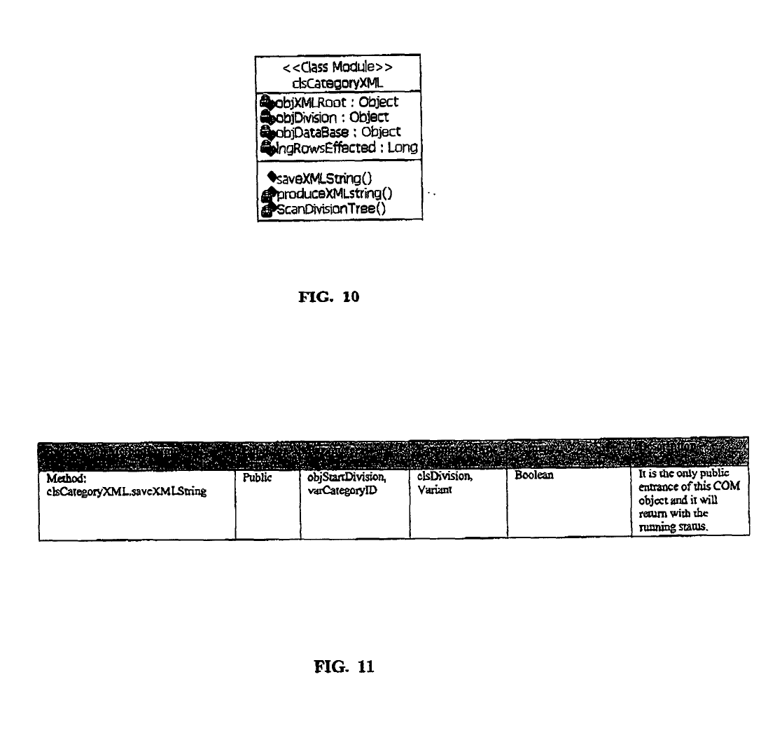

The clsCategoryXML object provides a method to generate the XML structure from a group of clsDivision objects and save it in the database. It returns the executing status. With respect to topology, this COM object just provides one public method as its entrance. With two parameters including the root clsDivision object and the primary ID of Category record, the method populates the Category XML structure by calling other private subroutines and functions, then saves the XML structure in table “Categories” and returns executing status as its result. With respect to constraints, the purpose of this COM object is to save an XML structure in the database. It cm be destroyed after its method is called. Therefore it can be placed in the MTS. Referring to FIG. 10, there is shown an entity diagram illustrating a clsCategoryXML COM object in accordance with one embodiment of the invention. Referring to FIG. 11, there is shown a table listing API interface descriptors for the clsCategoryXML COM object of FIG. 10.

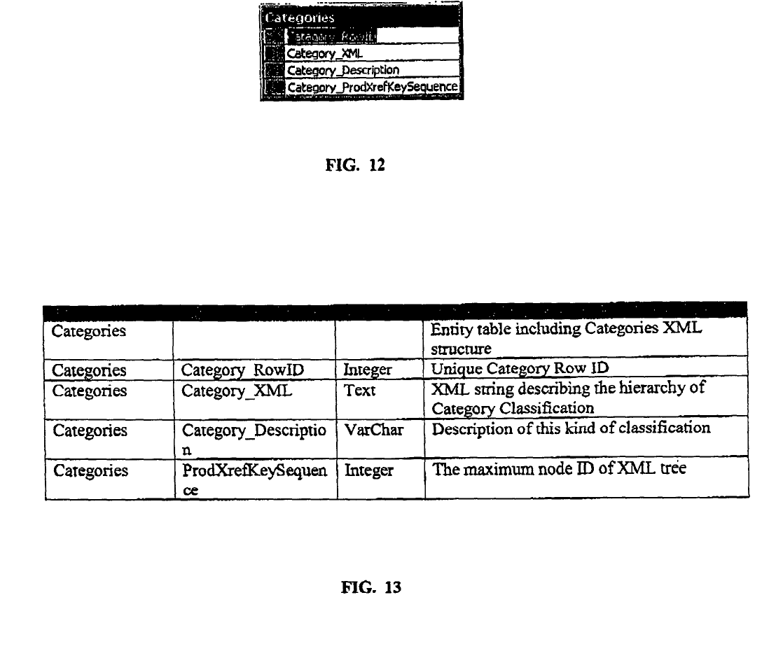

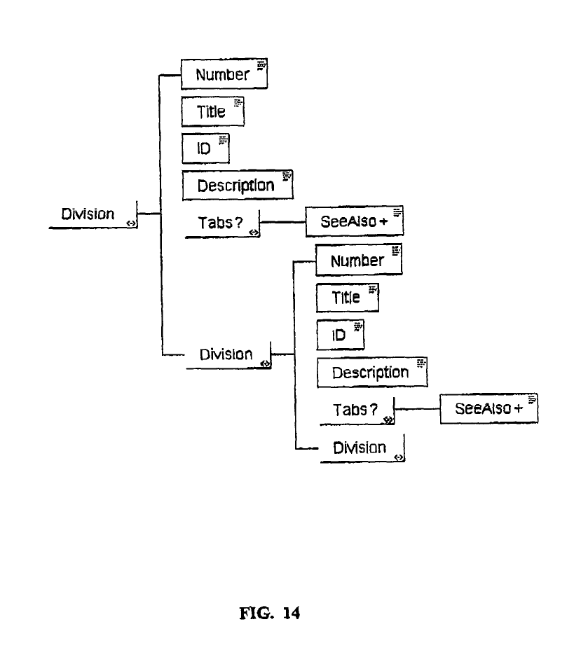

Database Tables. Referring to FIG. 12, there is shown an entity relationship diagram (ERD) illustrating tables related to the Category Administration application in accordance with one embodiment of the invention. Referring to FIG. 13, there is shown a table listing table and field descriptions corresponding to FIG. 12.

XML Menu Specification

Definitions. Consider the following definitions:

PDP: Product Display Page.

Dig box: Dialog box

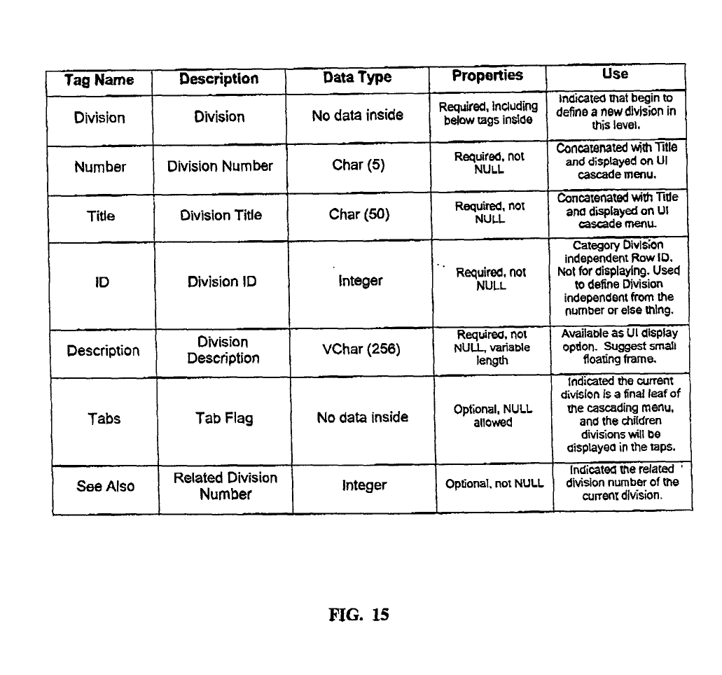

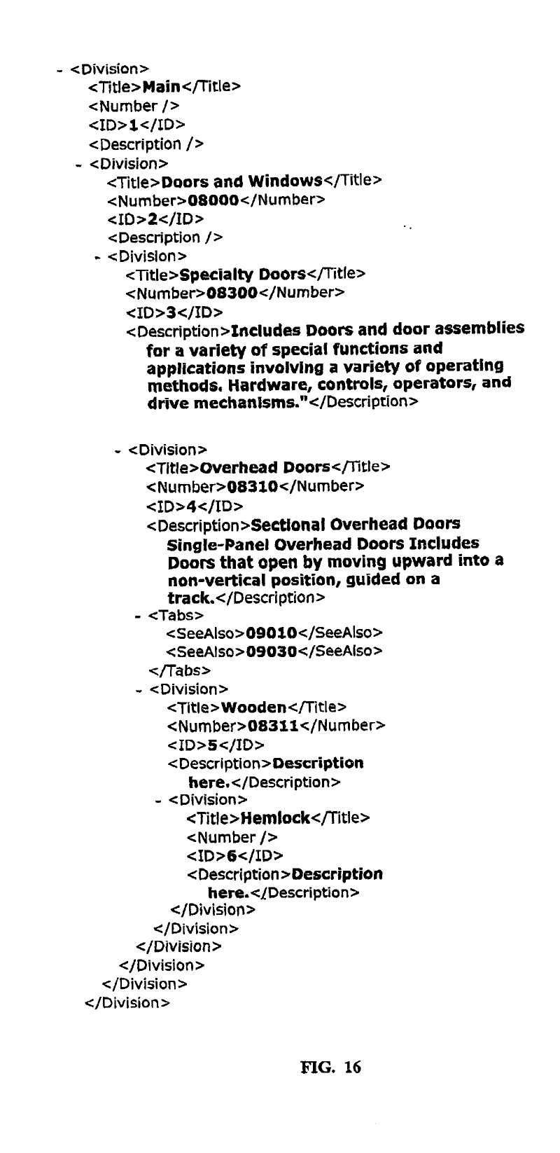

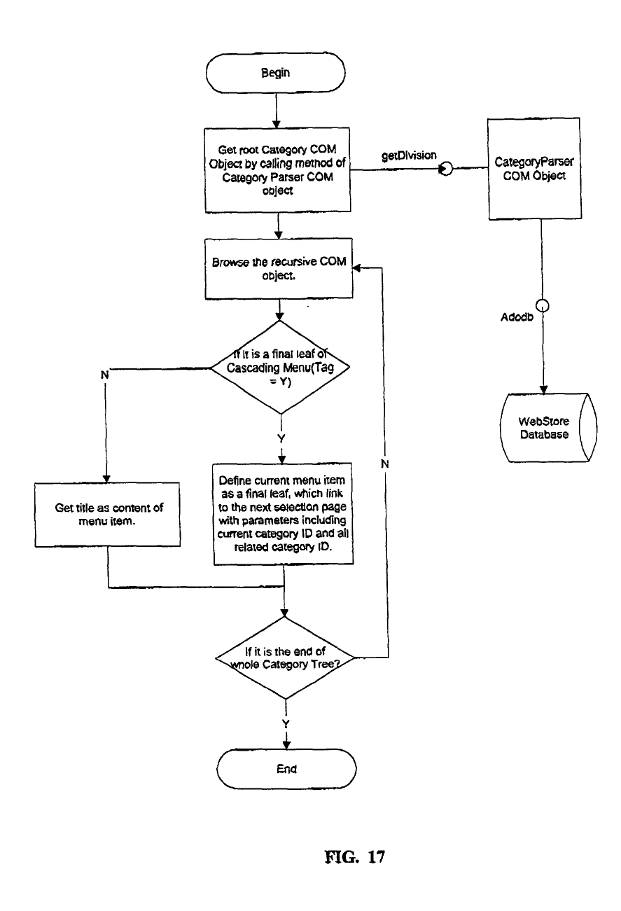

XML Structure. According to the present invention, the XML data structure is used to store all Categories data and structure. XML (Extensible Markup Language) is a markup language for documents containing structured information. XML is advantageous as it describes treemode structures very well. In addition, it also handles unknown level data structures well. According to the present invention, Categories data is organized as a multi-level hierarchy or tree structure. No restrictions are put on the number of levels or number of divisions per level. As mentioned above, an entire Material Breakdown Structure (MBS) Product classification is stored as an XML document, one XML document per MBS. The XML documents are stored as records in a table entitled “Categories”. Referring to FIG. 14, there is shown a block diagram illustrating a DTD (Document Type Definition) schema describing XML documents for MBS classifications in accordance with one embodiment of the invention. The DTD schema is used to validate editing of the XML document. The Categories XML is based on the DTD structure illustrated in FIG. 14. Referring to FIG. 15, there is shown a table listing tag descriptions for the DTD of FIG. 14. Referring to FIG. 16, there is shown a listing illustrating an exemplary Categories XML document in accordance with one embodiment of the invention.

Process Flow. In the following, the Category Selection application is described. This application allows users of the web page to find products by navigating one of two possible Category Classification indexes or Material Breakdown Structures (MBS) and to then choose a product from the tabs and expanding lists. The classification indexes are CSI Master Format and the applicant's proprietary format (see above). Other indexes may also be implemented.

The MBS indexes are displayed on the web page as a cascading multi-level hierarchy of categories and subcategories. The user interface may appear as a cascading menu. Each index or classification entry may be referred to as a Division as in CSI.

All divisions and their arbutes are placed in an XML string and stored in the database. A COM object is provided for storing a single division. All divisions can be saved in a group of this type of COM objects. These COM objects can be linked by collection. Hence, a COM objects linked list is produced from which all the branches from the root COM object can be browsed. Another COM object is provided which has an interface returning the root division entity COM object (see below).

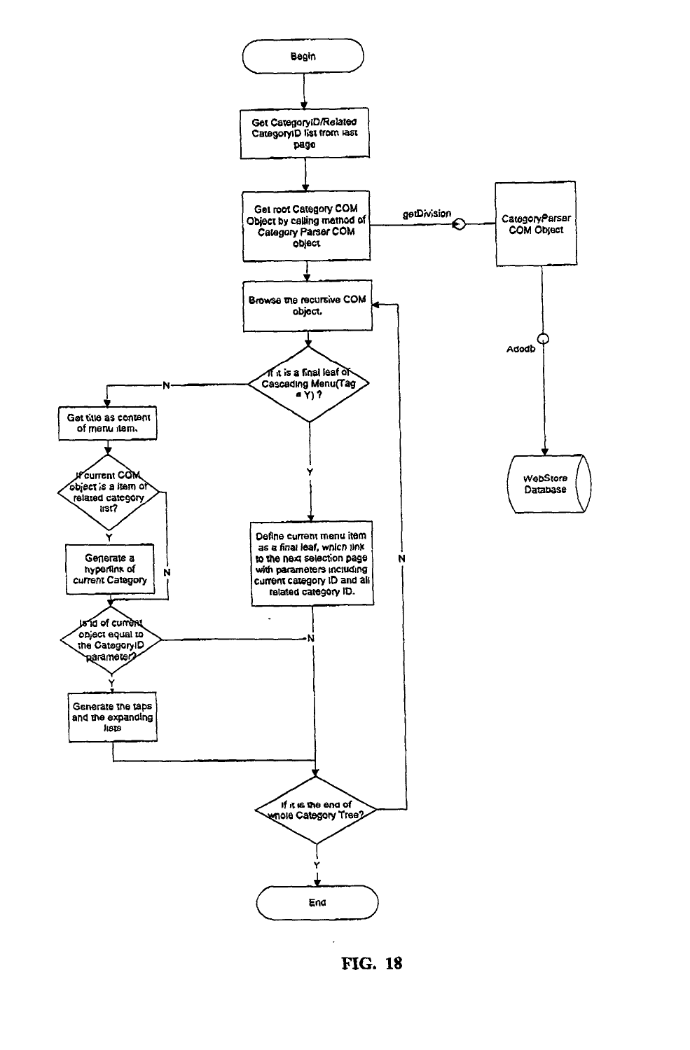

Referring to FIG. 17, there is shown a flowchart illustrating a category selection method for a first page including cascading menu in accordance with one embodiment of the invention. Referring to FIG. 18, there is shown a flowchart illustrating a category selection method for a selection page in accordance wit one embodiment of the invention.

Screens. In the following, a description is provided for screen design, position and purpose of controls, and how the controls on a screen interact with middle-tier objects (see below). Two screens are described: the first page screen and the selection page screen.

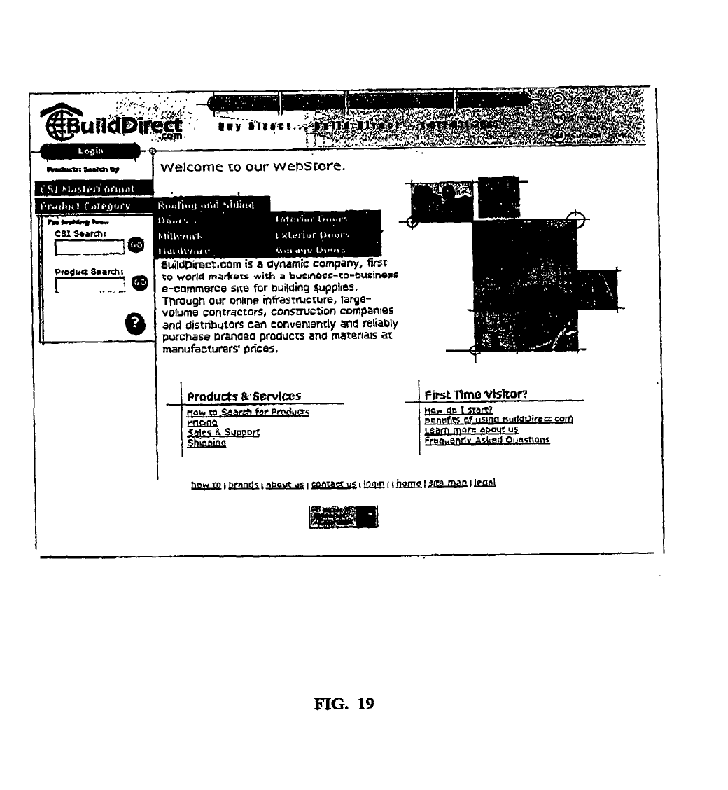

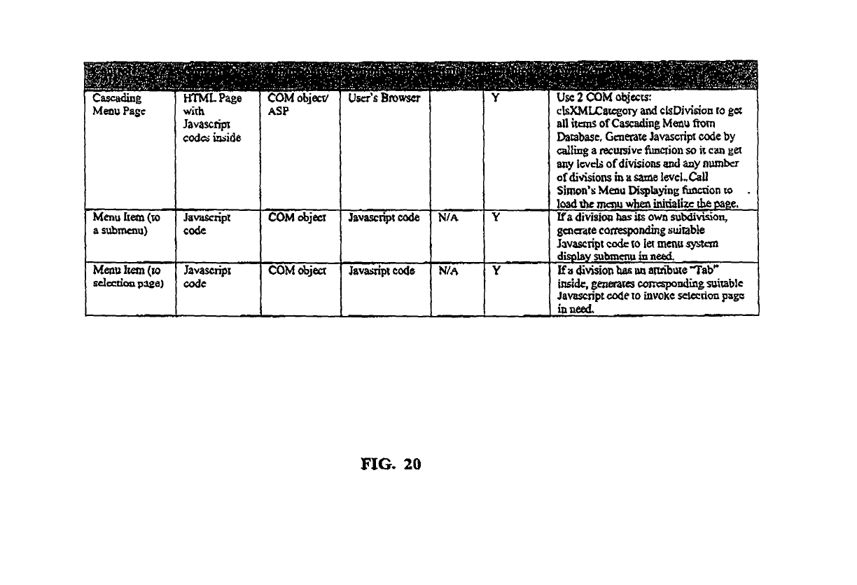

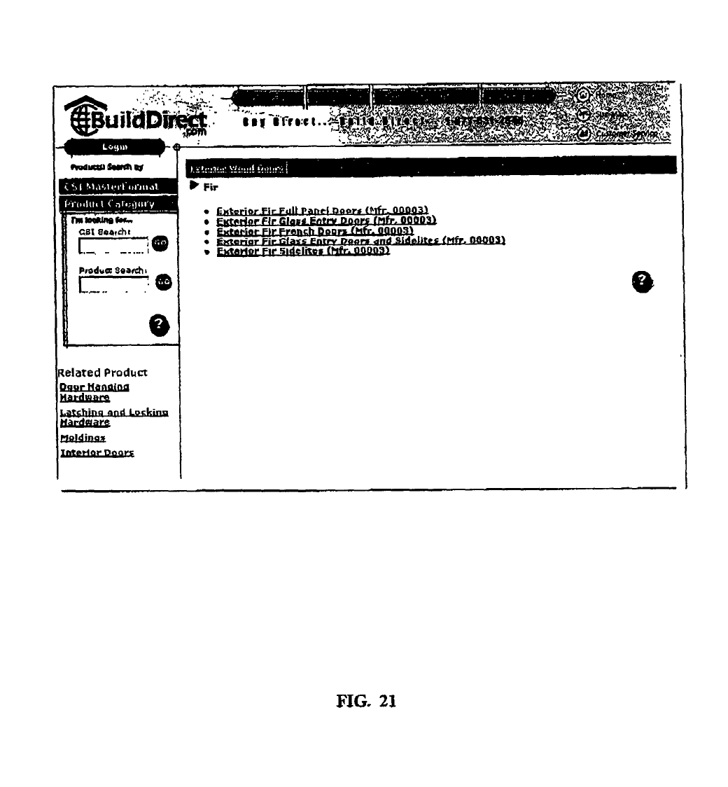

Referring to FIG. 19, there is shown a screen capture illustrating a first page screen in accordance with one embodiment of the invention. Preferring to FIG. 20, there is shown a table listing controls used in the first page screen of FIG. 19. The first page includes a cascading menu and introduction to the catalog provider. The cascading, menu is generated from the XML data and its final leaf links to the next selection page.

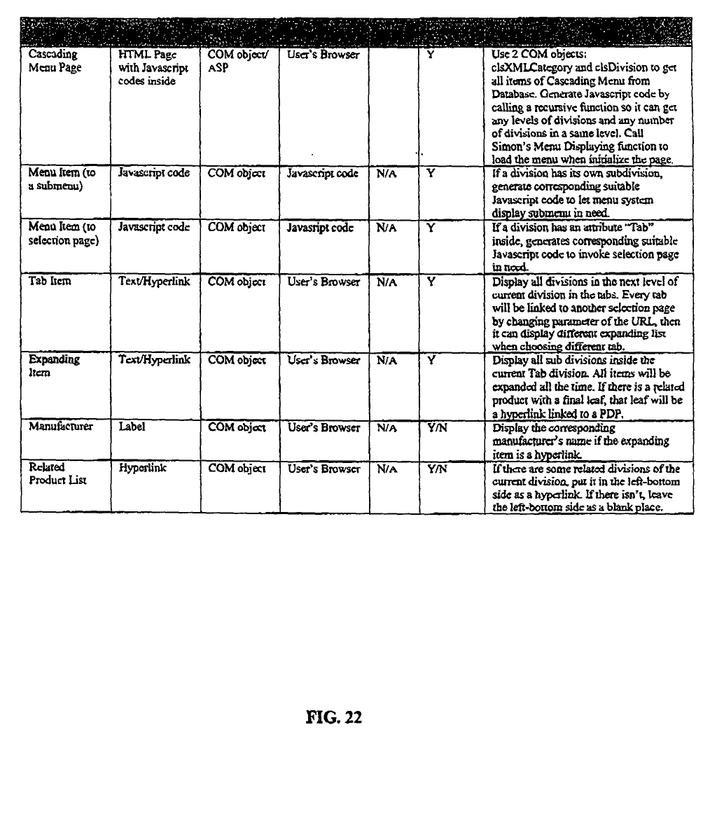

Referring to FIG. 21, there is shown a screen capture illustrating a selection page screen in accordance with one embodiment of the invention. Referring to FIG. 22, there is shown a table listing controls used in the selection page screen of FIG. 21. The selection page is generally the next page displayed after the first page (FIG. 19). When a final leaf of the cascading menu is chosen (i.e. clicked by a user), values related to that leaf are generally sent the selection page as parameters. Related Products list, Tabs and expanding lists would be displayed by these parameters. The final leaf of the expanding list can be a hyperlink to a PDP, if it has a corresponding product, or it can be a text string if it does not have a related product Each item of the Related Products can be a hyperlink to another selection page.

Middle Tier Objects. Middle tier objects for the XLS menu application include the following:

clsDivision: Serves to hold information of every division, it will include a collection of clsDivision object recursively if in need.

clsXMLCategory: Provides method to return the first root clsDivision object from Category XML structure stored in database.

With respect to object dependence, the clsDivision object with its collection of sub clsDivision objects recursively exists to be populated by the clsXMLCategory object and to be passed back to the ASP page for Cascading Menu displaying.

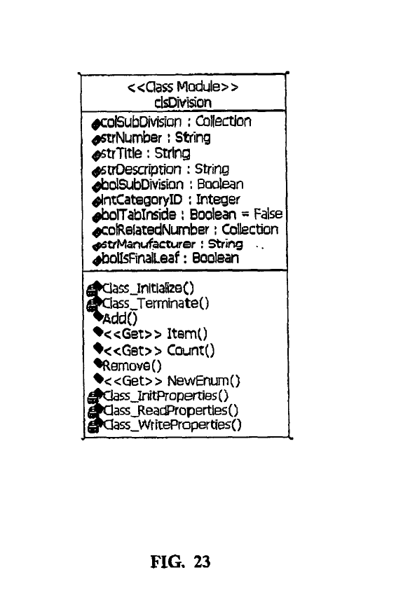

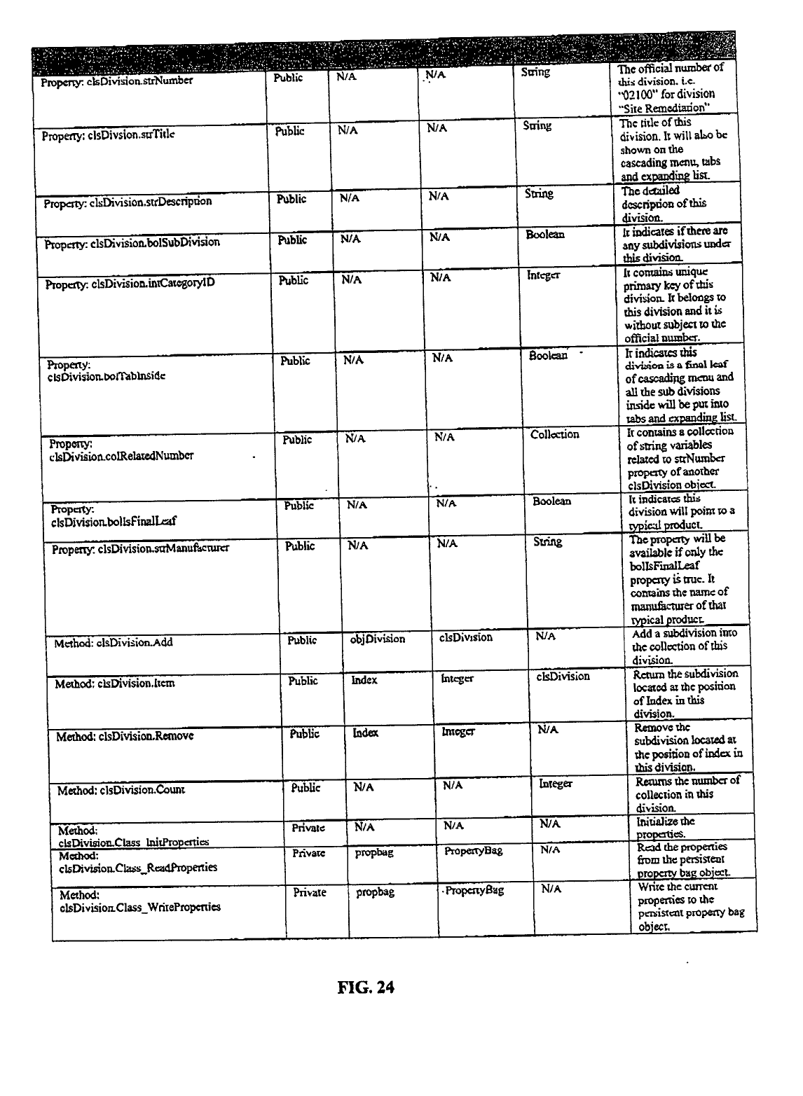

The clsDivision object serves to hold information for every division. It includes a collection of clsdivision objects recursively if required. Consequently, the items Entire Categories Structure, Cascading menu, Tabs and Expanding Lists, will be captured when browsing through this object and its children. With respect to topology, the clsdivision object is a recursive object. This means that it can include a collection of objects with the same structure as itself. So any level of division and any numbers of divisions in the same level will be available via this topology. With respect to constraints, the clsDivision holds required information. Referring to FIG. 23, there is shown an entity diagram illustrating a clsDivision COM object in accordance with one embodiment of the invention. Referring to FIG. 24, there is shown a table listing API interface descriptors for the clsDivision COM object of FIG. 23.

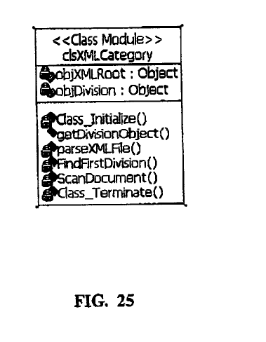

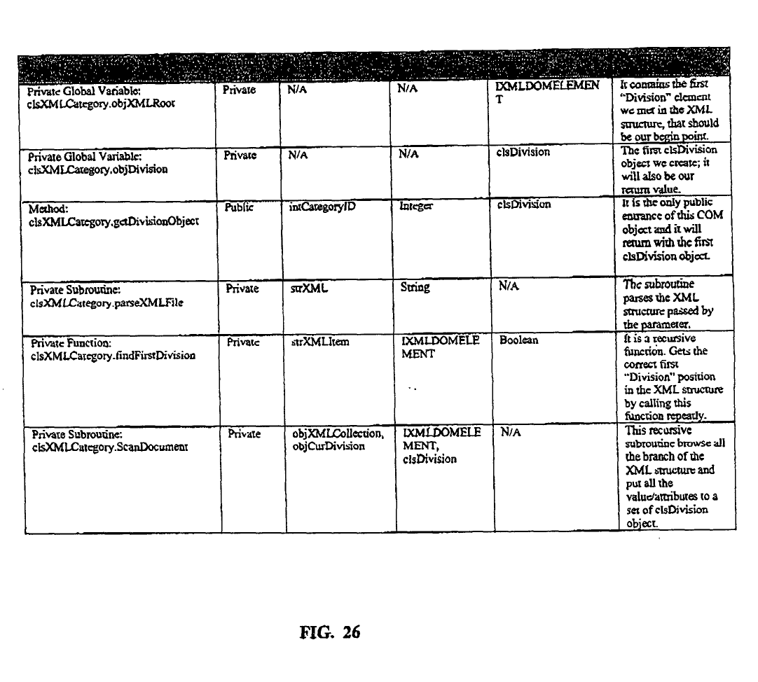

The clsXMLCategory object provides a method to generate a group of clsDivision objects related to every branch of the Category Division Tree from the Category XML structure stored in the database. It returns the first root clsDivision object. With respect to topology, this COM object provides one public method as its entrance. With only one parameter pointing to the primary key of the Category record in the Categories table, the method parses the Category XML structure by calling other private subroutines and functions. It then passes the first clsDivision object back as its result. With respect to constraints, the purpose of this COM object is to parse an XML structure and return a clsDivision object. It can be destroyed after its method is called. Therefore it can be placed in the MTS. For persisting the clsdivision objects, a condition tester is placed at the beginning of the function. That is, if the COM objects cannot be found in a typical file, it will be populated from the database and put it in the file; but if the CON objects can be found in that file, then the COM objects are obtained from the file. The latter is case being more efficient. Referring to FIG. 25, there is shown an entity diagram illustrating a clsXMLCategory COM object in accordance with one embodiment of the invention. Referring to FIG. 26, there is shown a table listing API interface descriptors for the clsXMLCategory COM object of FIG. 25.

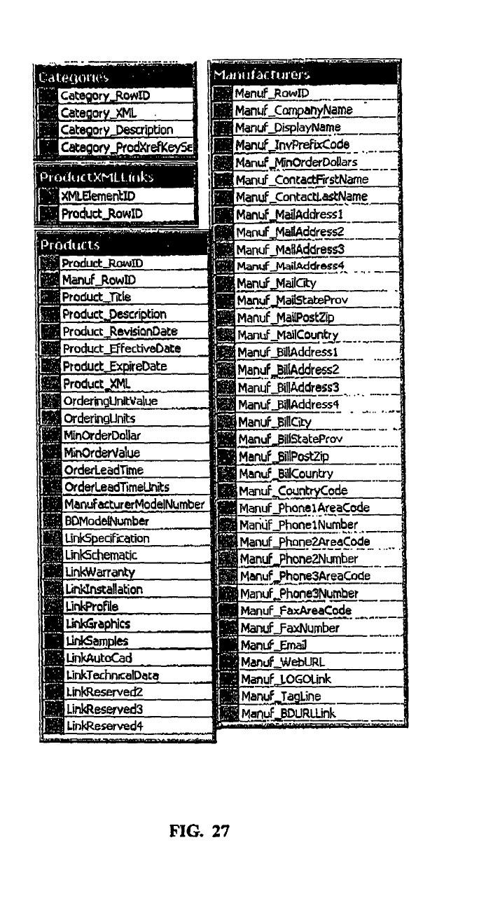

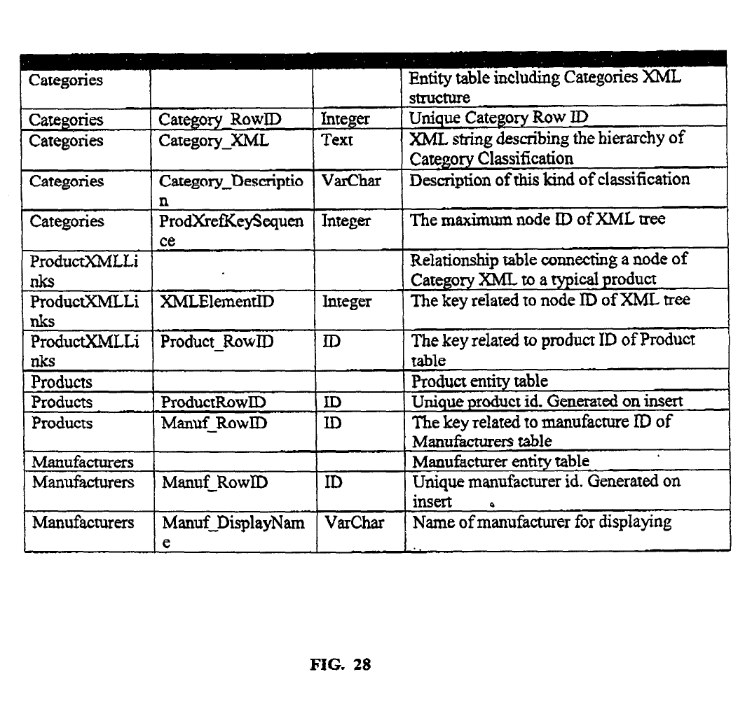

Database Tables. Referring to FIG. 27, there is shown an entity relationship diagram (ERD) illustrating tables related to the XML Menu Specification application in accordance with one embodiment of the invention. Referring to FIG, 28, there is shown a table listing table and field descriptions corresponding to FIG. 27.

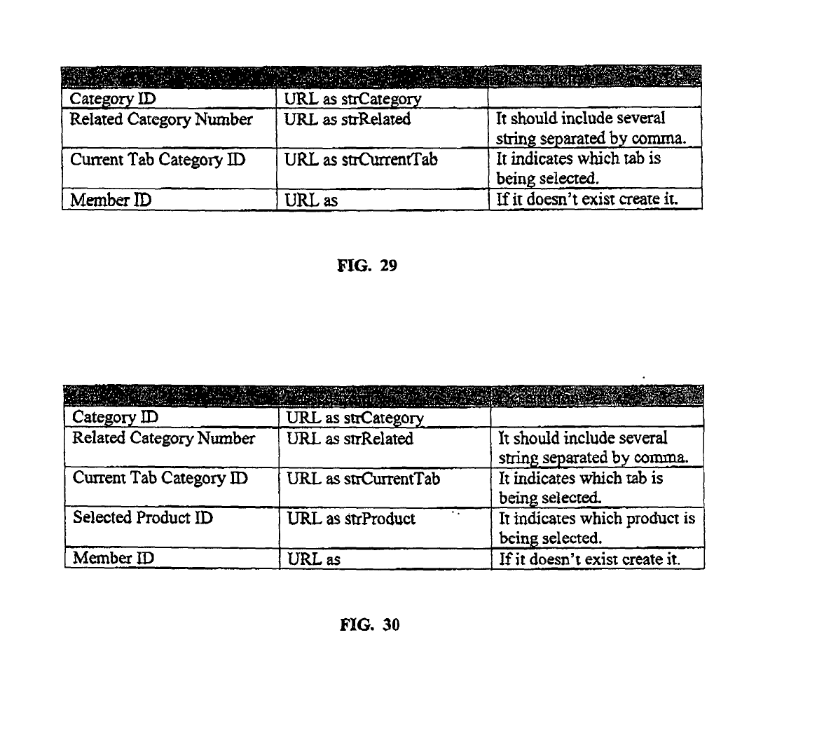

Interfaces. Referring to FIG. 29, there is shown a table listing interfaces to a selection page for the XML Menu Specification application in accordance with one embodiment of the invention. Referring to FIG. 30, there is shown a table listing interfaces to a product display page (PDP) for the XML Menu Specification application in accordance with one embodiment of the invention.

Product Specification

Definitions. Consider the following definitions:

PDP: Product Display Page.

Dig box: Dialog box

Process Flow. In the following, the Product Specification application is described. In the application, a product is specified or described as follows:

A product is described with a number of characteristics (i.e. domains), each of which can have multiple values. For example, a product of class “garage door” may have different variations in length (e.g. 5′, 6′ and 7) and color (e.g. white, almond, etc.).

A product is described and its other information (ie: warranty, image displayed) is populated by selecting an option from each of the domains that describe the product. For example, if a garage door has 6 domains (e.g. height, width, number of panels, color, and headroom), 1 characteristic from each of the 6 domains is selected to determine what the garage door will look like and what the price will be.

Unit price is determined after an item from each of the domains has been selected. This unit price can be calculated by one of two methods: (1) by adding the option price that may be attached to each of the domain items and (2) by looking up an overriding price or sale price.

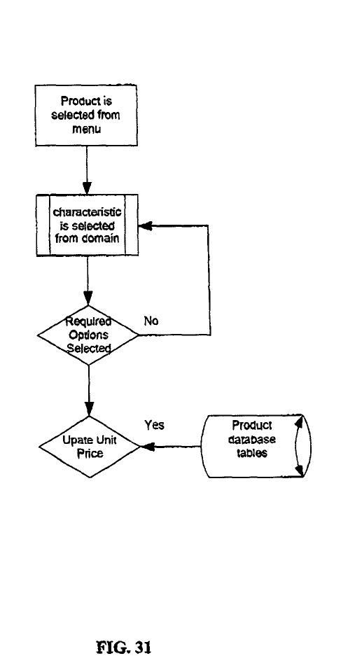

Referring to FIG. 31, there is shown a flowchart illustrating a product specification method in accordance with one embodiment of the invention.

Screens. In the following, a description is provided for screen design, position and purpose of controls, and how The controls on a screen interact with middle-tier objects (see below). Two screens are described: a product screen and an additional information screen.

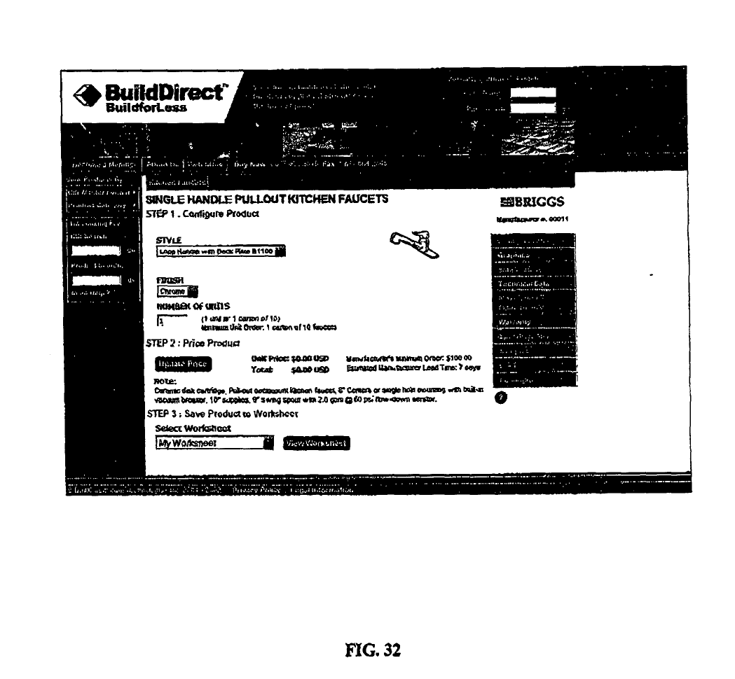

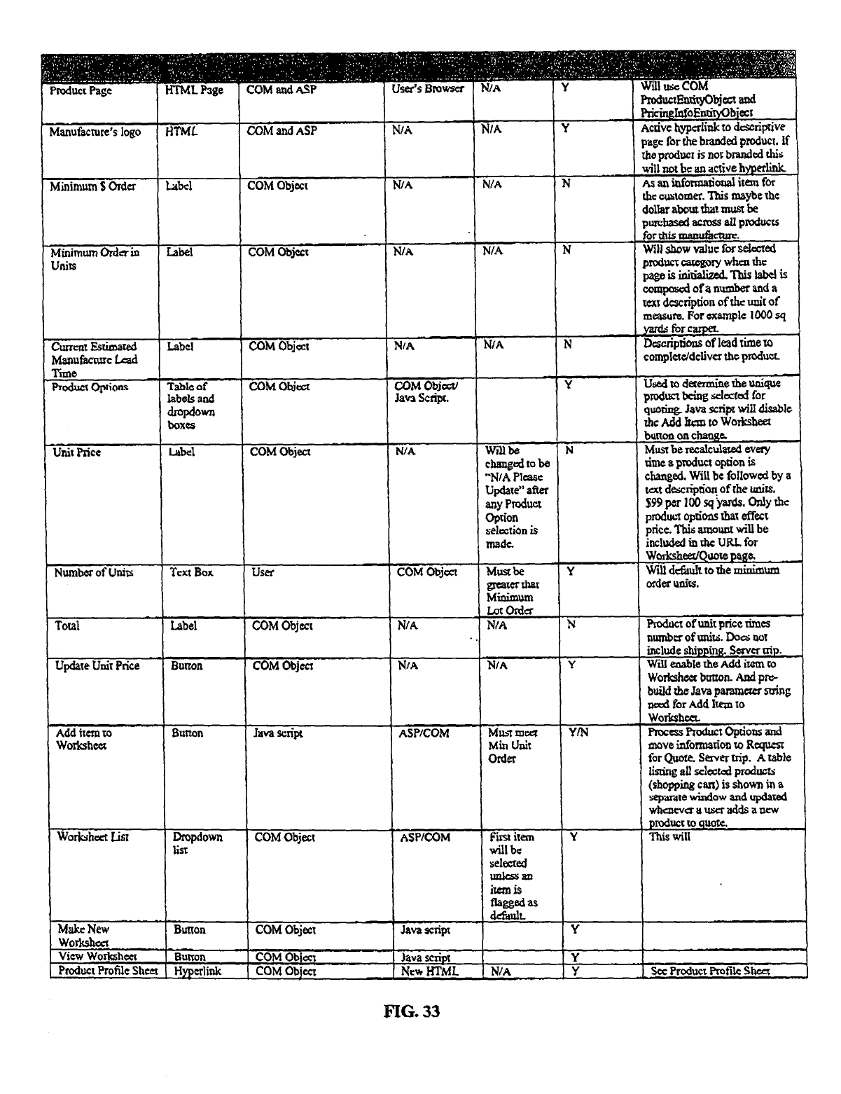

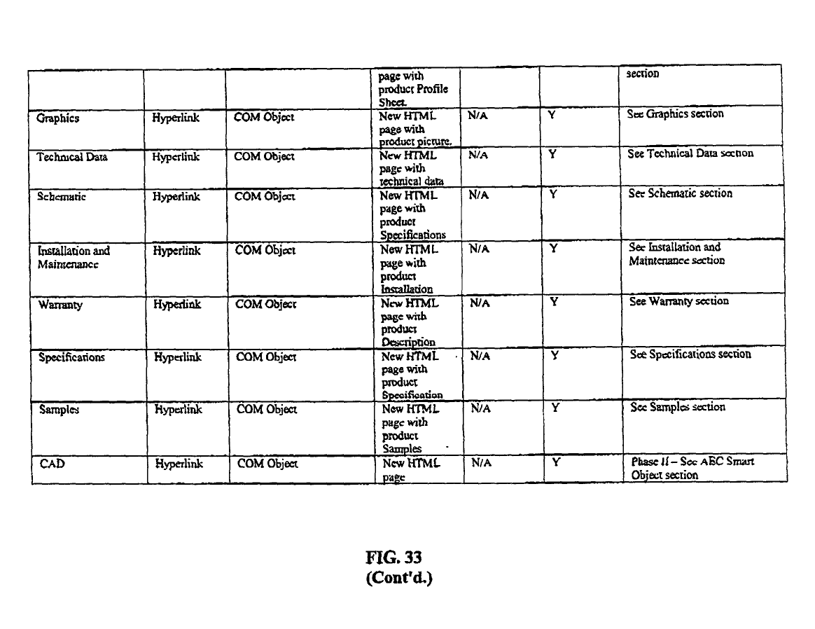

Referring to FIG. 32, there is shown a screen capture illustrating a product screen in accordance with one embodiment of the invention Referring to FIG. 33, there is shown a table listing controls used in the first page screen of FIG. 32. The product screen can include a “Manufacturer's Profile” box which can be placed in the upper left-hand corner of the screen, using the manufacturer's trademark graphic. Activating this box will provide an information page about the manufacturer (i.e. text and pictures may be provided by the manufacturer). Below the Manufacturer's Profile box, a box for a short promotional statement about the manufacturer may be included.

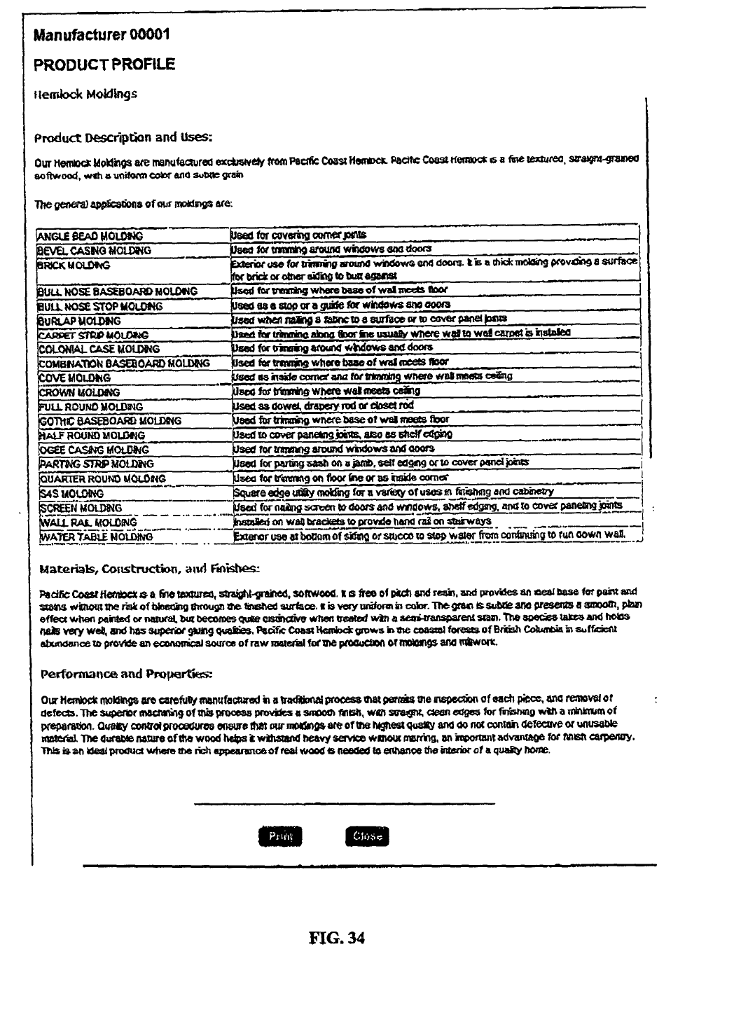

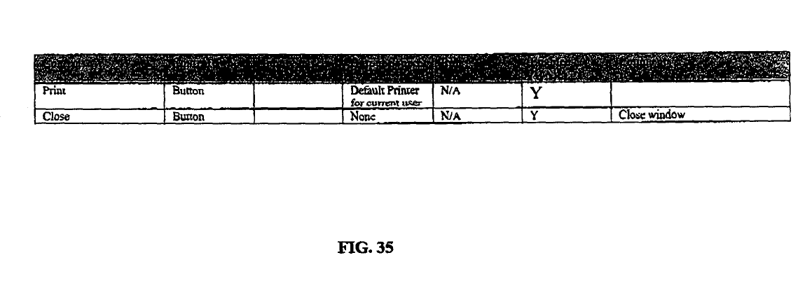

Referring to FIG. 34, there is shown a screen capture illustrating an additional product information screen in accordance with one embodiment of the invention. Referring to FIG. 35, there is shown a table listing controls used in the additional product information screen of FIG. 34.

Middle Tier Object. Middle tier objects for the Product Specification application include the following:

cProductEntityObject: Used to hold state when selecting or building a Product.

cProductBroker: Methods used to load the Product Entity Object and provide pricing data.

cPricingInfoEntityObject: Used to hold unit pricing information when Pricing Update function is selected.

With respect to object dependence, the entity object, ProductEntity, and PricingInfoEntity exist to be populated by ProductBroker and to be passed back to the page for display.

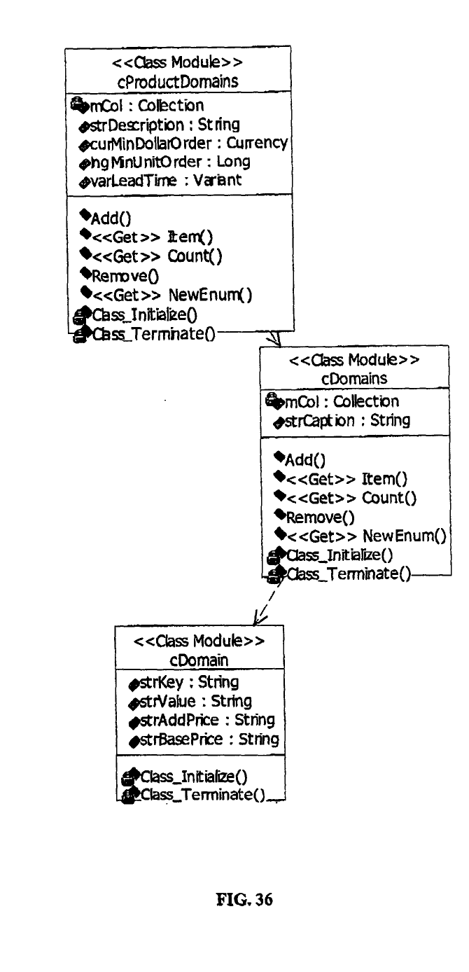

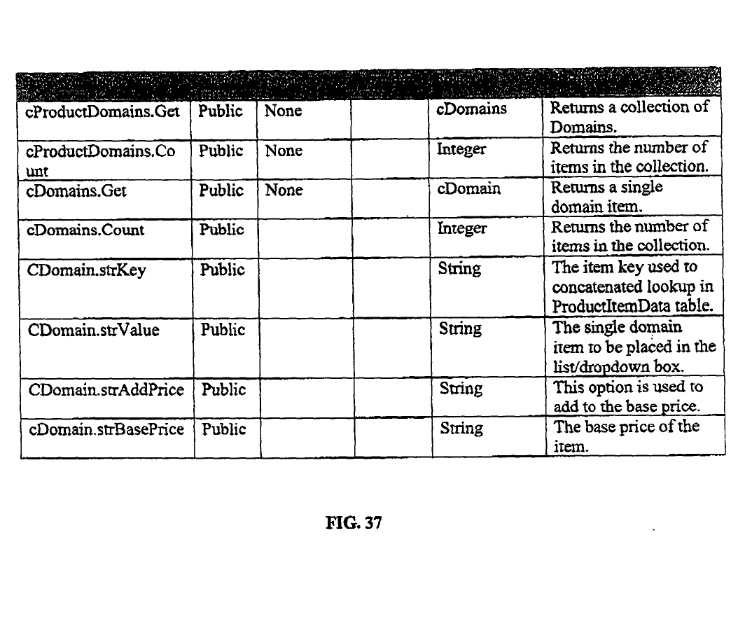

The Product Entity object is used to hold the state when selecting or building a Product for display. Referring to FIG. 36, there is shown an entity diagram illustrating a Product Entity object in accordance with one embodiment of the invention. Referring to FIG. 37, there is shown a table listing API interface descriptors for the Product Entity object of FIG. 36.

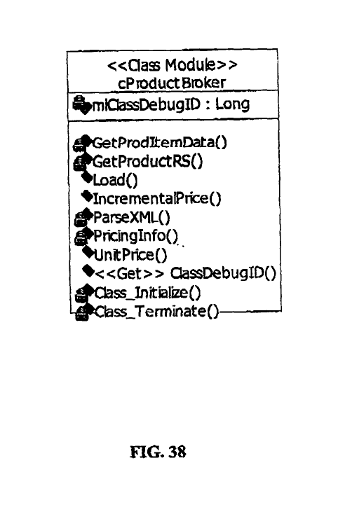

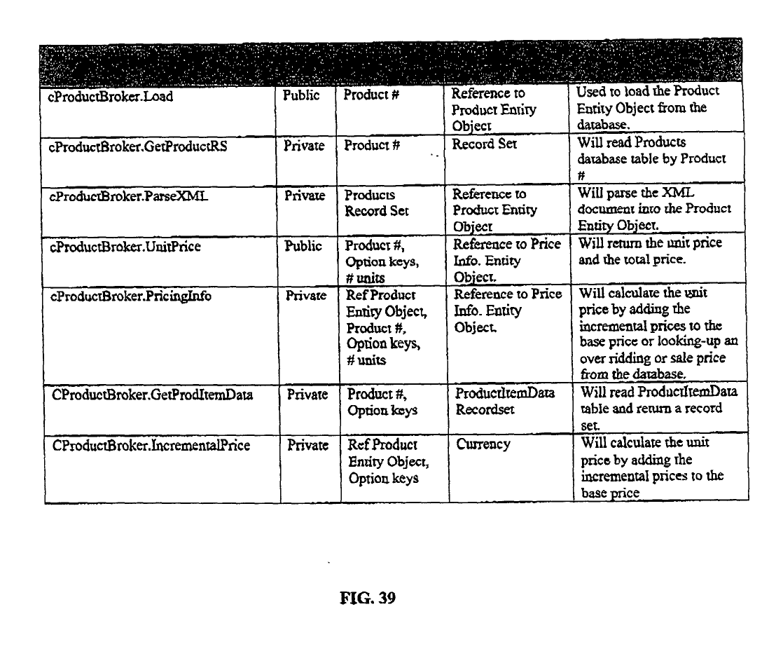

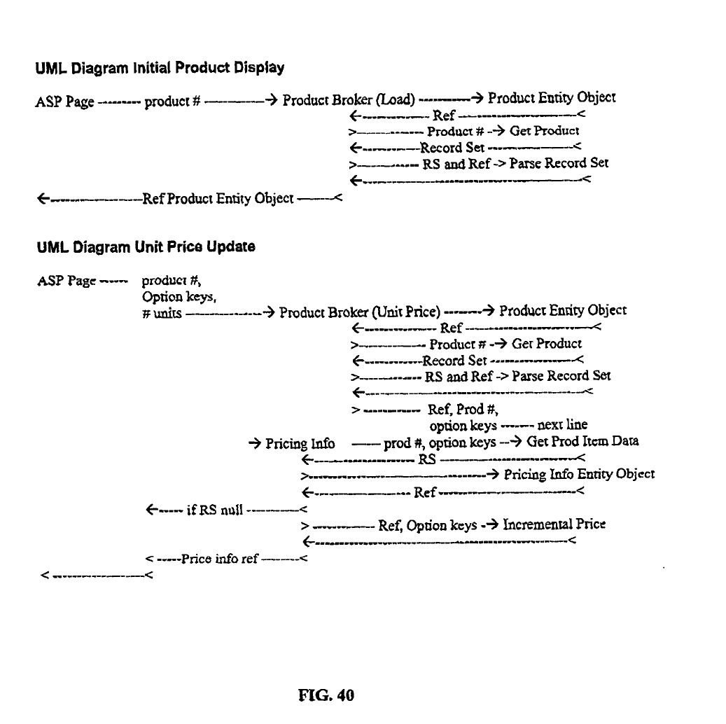

The Product Broker object is the method used to load the Product Entity Object and to retrieve pricing information from the database. Referring to FIG. 38, there is shown an entity diagram illustrating a Product Broker object in accordance with one embodiment of the invention. Referring to FIG. 39, there is shown a table listing API interface descriptors for the Product Broker object of FIG. 38. Referring to FIG. 40, there is shown a UML diagram for the Product Broker object of FIG. 38.

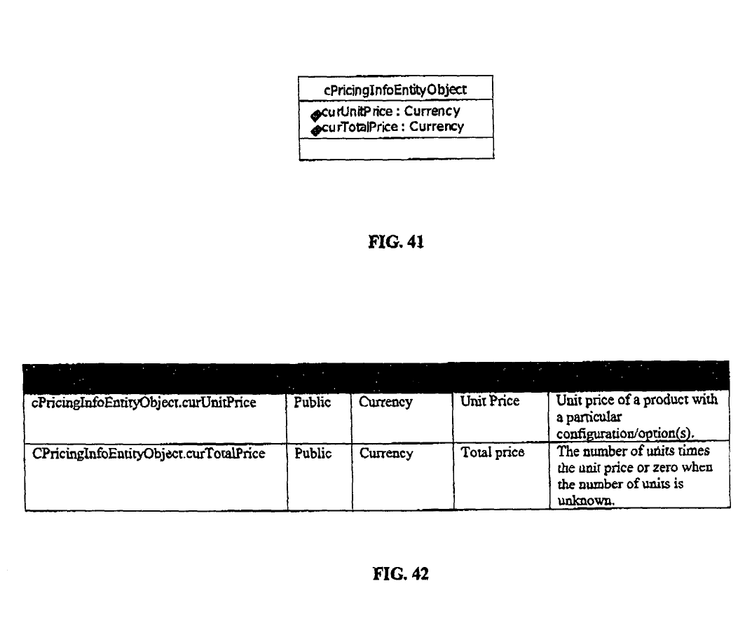

The Pricing Info Entity object is used to hold the unit price and the total price of a product from the Product Display form. Referring to FIG. 41, there is shown an entity diagram illustrating a Pricing Info Entity object in accordance with one embodiment of the invention. Referring to FIG. 42, there is shown a table listing API interface descriptors for the Pricing Info Entity object of FIG. 41.

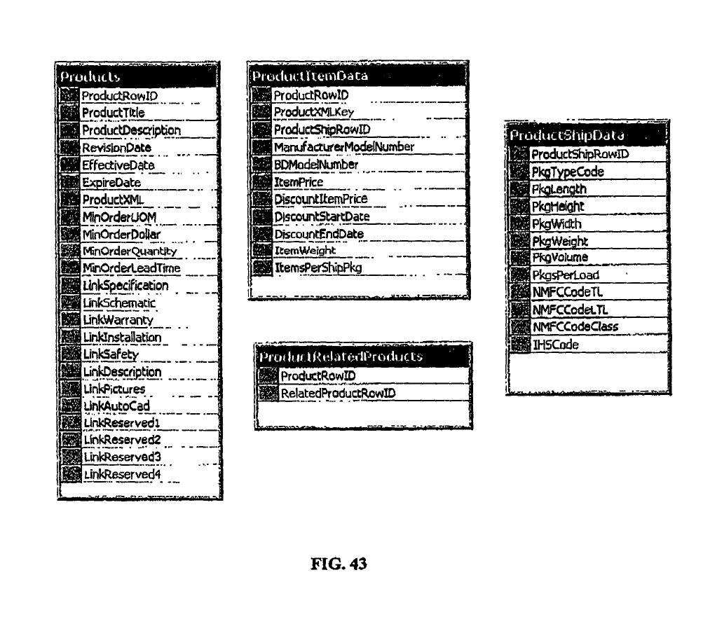

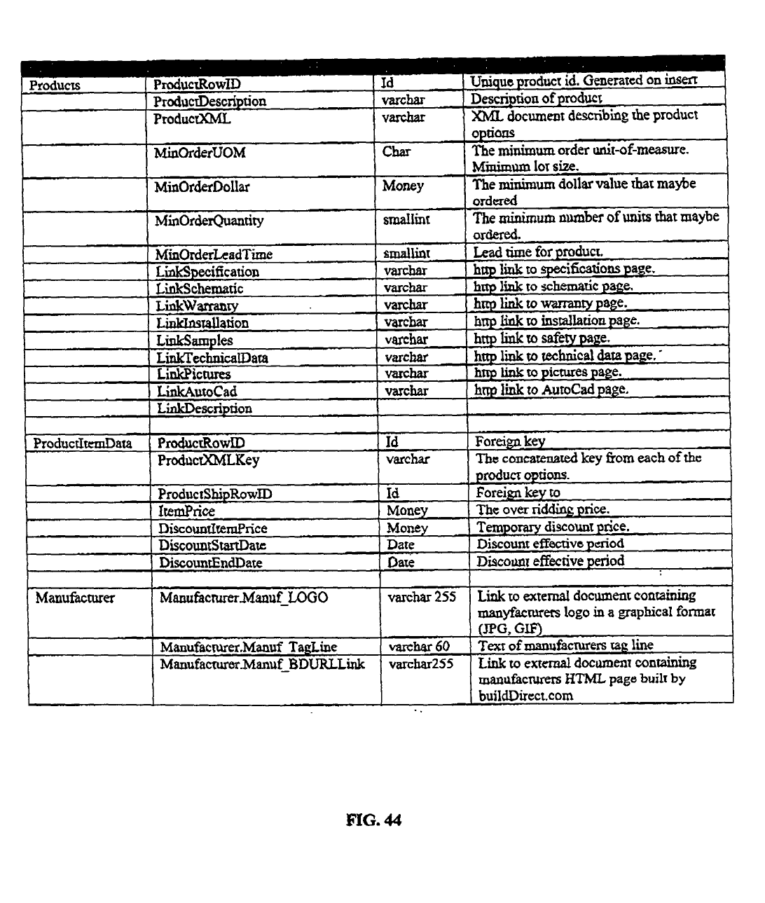

Database Tables. Referring to FIG. 43, there is shown an entity relationship diagram (ERD) illustrating tables related to the Product Specification application in accordance with one embodiment of the invention. Referring to FIG. 44, there is shown a table listing table and field descriptions corresponding to FIG. 43. The design can also be convert into an Relational Database to produce the same results.

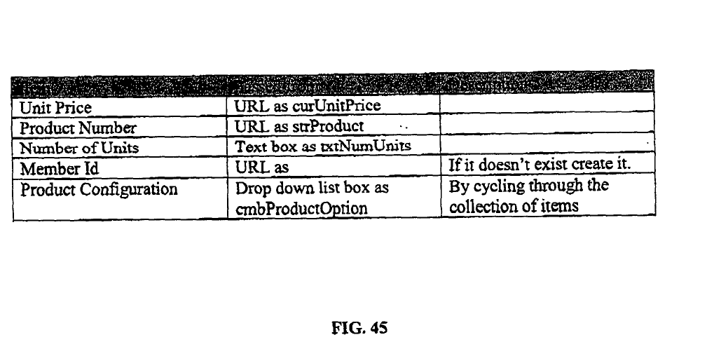

Interfaces. Referring to FIG. 45, there is shown a table listing interfaces to a worksheet for the Product Specification application in accordance with one embodiment of the invention.

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1. A method for cataloguing information for at least one family of products, each product in said family having at least one or more configurations, said method comprising the steps:
a) creating an XML document containing said product family information, including said product configurations;
b) storing said XML documents in a database, and associating with said document an identifier for said document;
c) allowing a user to select at least one family from a displayed list of families, such that when the user selects said family the XML documents corresponding thereto is retrieved from said database, using said identifier; and
d) presenting to said user, product information contained in said retrieved XML document.
